(19) United States
(12) Patent Application Publication
(10) Pub. No.: US 2012/0325004 A1
(43) Pub. Date: Dec. 27, 2012

(54) APPARATUS FOR PIPELINE INSPECTION AND METHOD OF PIPELINE INSPECTION

(76) Inventors: William HERRON, Ashington (GB); Robert PALMA, Stutensee (DE)

(21) Appl. No.: 13/481,223

(22) Filed: May 25, 2012

(30) Foreign Application Priority Data
May 26, 2011 (EP) 11167744.9

(51) Int. Cl. G01N 29/04

(52) U.S. Cl. 73/618

(57) ABSTRACT

An apparatus for pipeline inspection is provided. The apparatus comprising a body comprising a longitudinal axis a sensor unit in association with the body, wherein the sensor unit comprises an array of ultrasonic sensors configured to inspect a pipe wall and a skid comprising an outer surface configured to run adjacent to, or in contact with, the pipe wall, wherein the array of ultrasonic sensors are arranged at a stand off from the outer surface of the skid, and a mechanism configured to bias the outer surface of the skid into contact with the pipe wall, and to move the sensor unit between a first radial position and a second radial position in response to changes in pipe diameter.

### BACKGROUND OF THE INVENTION

1. Field of the Invention

Embodiments of the present invention relate to a pipeline inspection apparatus and a method of pipeline inspection.

2. Description of the Prior Art

It is known to carry out an inspection of a pipeline using an apparatus, commonly referred to as a pipeline pig, which travels inside the pipeline to measure or detect defects in the wall of the pipeline. Such an apparatus may include an array of ultrasonic sensors for measuring the wall thickness of the pipeline and/or for detecting cracks in the wall of a pipeline.

Conventionally, ultrasonic sensors are only used in liquid-filled pipelines, wherein the liquid in the pipeline provides a couple medium for transferring ultrasonic waves from the ultrasonic sensors to the pipe wall.

Typically, the ultrasonic sensors are mounted on a skid, which is designed to run adjacent or in contact with a pipe wall, e.g. as a pig carries out an inspection run through a pipeline. The sensors are arranged at a stand off from the outer surface of the skid, in order to protect the sensors against wear or other damage from contact with the pipe wall.

A conventional skid consists of a generally helical elongate member, which is arranged in a bowed configuration between a pair of skid cups (one at either end of the skid). This configuration is used to provide a clamping force between the outer surface of the skid and an inner surface of the pipe.

It is desirable to maintain a generally constant stand off between the sensors and the pipe wall during an inspection run along a pipeline. However, this is not always possible using a conventional skid of the kind discussed above, particularly in bends.

A particular problem is that conventional skids and skid cups consist of thick plastics parts. These parts are required to deform through bends and other pipeline features. However, the mode of deformation is rarely uniform, which makes it difficult to control the clamping force that a conventional skid will provide against the pipe wall.

In order to address this problem, it is known to provide leaf springs which act on the skid, in an attempt to ensure that the skids remain biased against the pipe wall through bends or changes in pipe diameter etc. However, the design process relies heavily on trial and error and cannot be modelled acurately.

### BRIEF SUMMARY OF THE INVENTION

According to an embodiment of the present invention, an apparatus for pipeline inspection is provided. The apparatus comprising a body comprising a longitudinal axis a sensor unit in association with the body, wherein the sensor unit comprises an array of ultrasonic sensors configured to inspect a pipe wall and a skid comprising an outer surface configured to run adjacent to, or in contact with, the pipe wall, wherein the array of ultrasonic sensors are arranged at a stand off from the outer surface of the skid, and a mechanism configured to bias the outer surface of the skid into contact with the pipe wall, and to move the sensor unit between a first radial position and a second radial position in response to changes in pipe diameter.

According to an embodiment of the present invention, there is provided a method of pipeline inspection using an apparatus comprising a sensor unit comprising an array of ultrasonic sensors configured to inspect a pipe wall, a skid comprising an outer surface configured to run adjacent to, or in contact with, the pipe wall, and a mechanism configured to bias the outer surface of the skid into contact with the pipe wall, the pipeline comprising a first section with a first bore diameter and a second section with a second bore diameter which is different from the first bore diameter. The method comprising moving the apparatus on a continuous run through the first section and the second section of the pipeline, positioning, with the mechanism, the sensor unit against an inner surface of the first section of the pipeline, and automatically repositioning, with the mechanism, the sensor unit against an inner surface of the second section of the pipeline upon a change in bore diameter between the first section and the second section of the pipeline.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic perspective view of a vessel forming part of an apparatus for pipeline inspection according to an embodiment of the present invention;

FIG. 2 is a schematic perspective view of a sensor unit and carrier for use in a vessel according to an embodiment of the present invention;

FIG. 3 is a schematic perspective view of the carrier in FIGS. 1 and 2 according to an embodiment of the present invention;

FIG. 4 is a schematic perspective view of a vessel comprising multiple sensor units according to an embodiment of the present invention; and

FIG. 5 is a schematic diagram showing a vessel of FIG. 4 operable through a pipeline having multiple bore diameters according to an embodiment of the present invention.

### DETAILED DESCRIPTION OF THE INVENTION

The following description of the exemplary embodiments refers to the accompanying drawings. The same reference numbers in different drawings identify the same or similar elements. The following detailed description does not limit the invention. Instead, the scope of the invention is defined by the appended claims.

Reference throughout the disclosure to “an exemplary embodiment,” “an embodiment,” or variations thereof means that a particular feature, structure, or characteristic described in connection with an embodiment is included in at least one embodiment of the subject matter disclosed. Thus, the appearance of the phrases “in an exemplary embodiment,” “in an embodiment,” or variations thereof in various places throughout the disclosure is not necessarily referring to the same embodiment. Further, the particular features, structures or characteristics may be combined in any suitable manner in one or more embodiments.

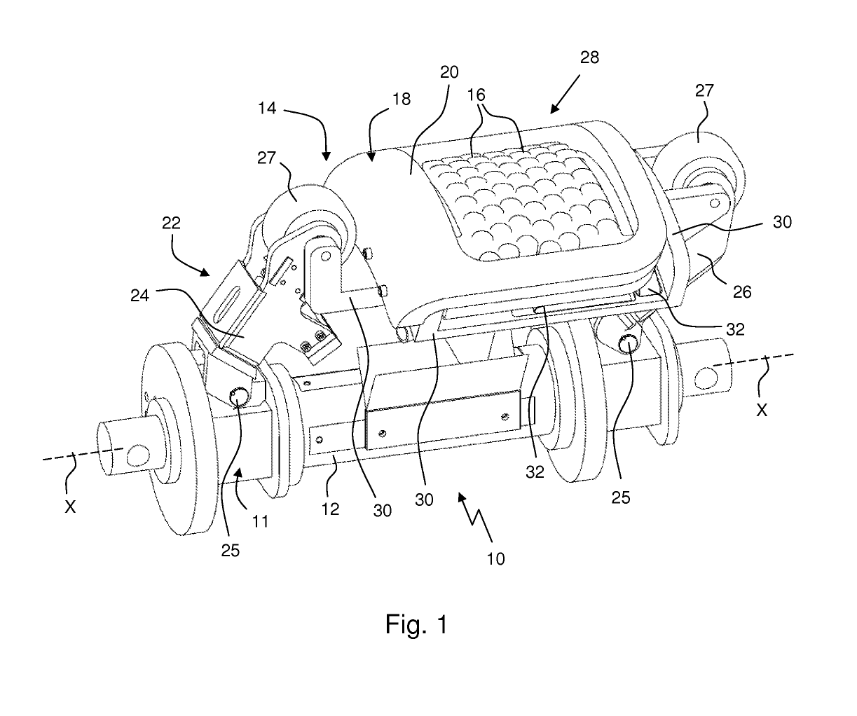

Referring firstly to FIG. 1, part of a pipeline inspection apparatus for in-line inspection of pipelines is indicated generally at 10.

The apparatus 10 includes a vessel 11 having a central body 12 and a longitudinal axis X (extending left to right as viewed in FIG. 1). A sensor unit 14 is mounted on said body 12. The sensor unit 14 includes an array of ultrasonic sensors 16 for inspecting a pipe wall.

The sensor unit 14 includes a skid 18 having an outer surface 20 intended to run adjacent or in contact with a pipe wall, in use. The outer surface 20 is arcuate in a circumferential direction with respect to the longitudinal axis X. The ultrasonic sensors 16 also define an arcuate inspection plane in a circumferential direction with respect to the longitudinal axis X. The inspection plane is arranged at a stand off from the outer surface 20 of the skid 18 (for example, radially inward of the outer surface 20), for protecting the ultrasonic sensors 16 against wear or other damage from contact with the pipe wall.

The ultrasonic sensors 16 within the inspection array can be orientated normally to the pipe wall for wall thickness evaluation or at an angle to the pipe wall so as to induce shear waves and identify any cracks in the pipeline, for example.

The apparatus 10 includes a spring-loaded mechanism 22 for permitting movement of the sensor unit 14 with respect to the longitudinal axis of the central body 12, for example, in response to changes in bore diameter.

The mechanism 22 is configured for biasing the sensor unit 14 in a generally radial direction, in order to bias the outer surface 20 of the skid 18 in the direction of a pipe wall. More particularly, the mechanism 22 is configured to move the sensor unit 14 between a first radial position (for example, a retracted position for use in a small diameter bore) and a second radial position (for example, an extended position for use in a large diameter bore), in response to changes in pipe diameter. The mechanism 22 is configured to position the sensor unit 14 at an appropriate radial position (for example, intermediate said first and second radial positions), depending on the size of the bore through which the apparatus 10 is passing. Hence, the apparatus 10 can be used for inspection of multi-diameter pipelines or across a range of pipelines having different diameters.

The mechanism 22 includes first and second suspension members 24, 26 configured for biasing the sensor unit 14 in the direction of a pipe wall (for example, in a radial or outward direction relative to the longitudinal axis X). The first and second suspension members 24, 26 are axially off set from one another, with respect to the longitudinal axis X of the central body 12.

The first and second suspension members 24, 26 are connected to body 12 by a spring-biased pivotal connection 25, so as to be configured to pivot relative to said longitudinal axis X of the central body 12. The suspension members 24, 26 are biased towards said second radial position (for example, an extended position relative to the body 12). Hence, the suspension members 24, 26 act as spring-biased struts or arms which are movable relative to the central body 12 of the vessel 11, for positioning the sensor unit 14 adjacent the pipe wall.

A roller 27 is provided at the end of each suspension member 24, 26, for rolling contact with the internal surface of a pipe along which the apparatus is travelling in use.

The first and second suspension members 24, 26 form part of a linkage 28, which is configured for movement of the sensor unit 14 radially with respect to the longitudinal axis X of the central body 12, for example, between the first radial position and second radial position, in response to changes in bore diameter as the suspension rollers 27 react against the pipe wall.

The linkage 28 includes a carrier 30 arranged for movement with said first and second suspension members 24, 26. The sensor unit 14 is mounted on said carrier 30.

The carrier 30 is mounted between the first and second suspension members 24, 26, and the carrier 30 is arranged to remain parallel with the longitudinal axis X of the central body 12 during movement of the sensor unit 14.

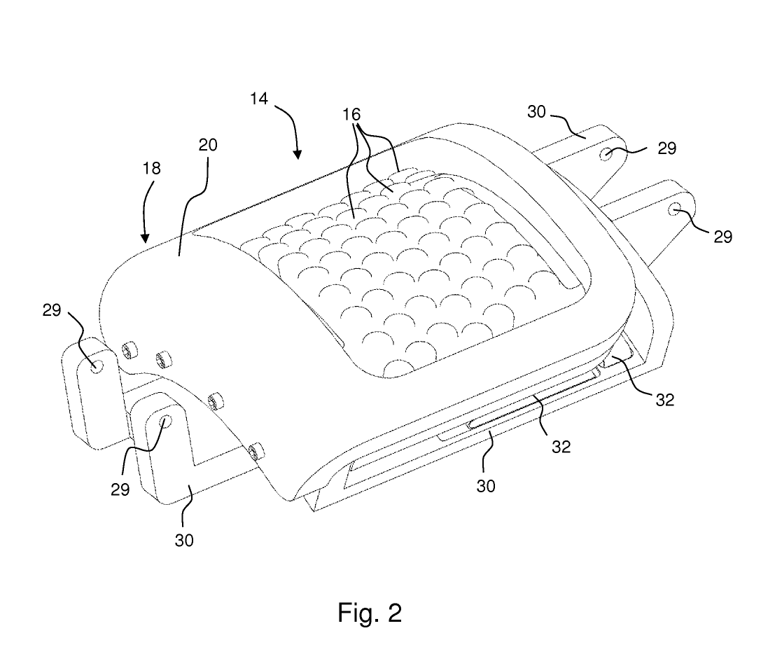

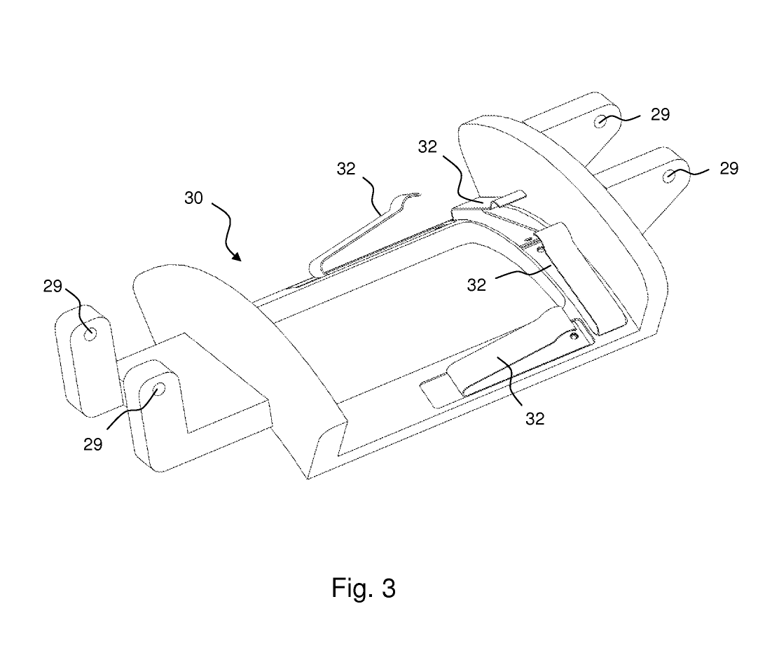

As shown in FIGS. 2 and 3, the carrier 30 includes pivot points 29 for connection to the first and second suspension members 24, 26.

As shown in FIG. 3, the carrier 30 comprises biasing elements in the form of leaf springs 32, which are arranged beneath the sensor unit 14. The biasing elements provide local biasing of the sensor unit 14 relative to the longitudinal axis X of the central body 12, for example, in the direction of the pipe wall.

The spring-loaded mechanism 22 ensures that the sensors 16 are deployed adjacent the pipe wall, even in bends (where conventional systems fail or are highly unreliable). Moreover, the localized biasing of the sensor unit 14 on the carrier 30 assists in providing correct orientation and clamping force of the skid 18 against the pipe wall.

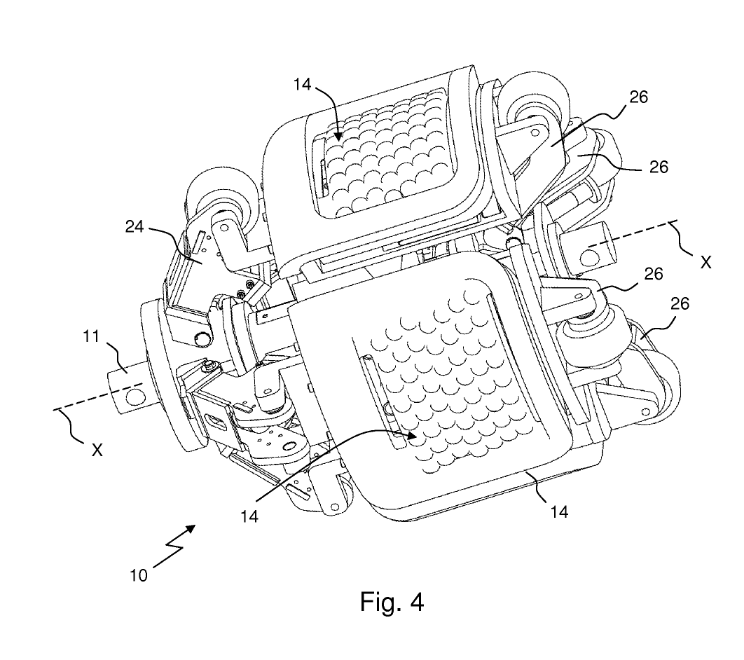

As shown in FIG. 4, the vessel 11 may be provided with multiple sensor units 14, each of which is movably mounted on said central body 12 in the manner described above. In one embodiment, the vessel 11 includes four sensor units 14 (only three of which are visible in FIG. 4) arranged at 90 degrees to one another in a ring about the longitudinal axis X.

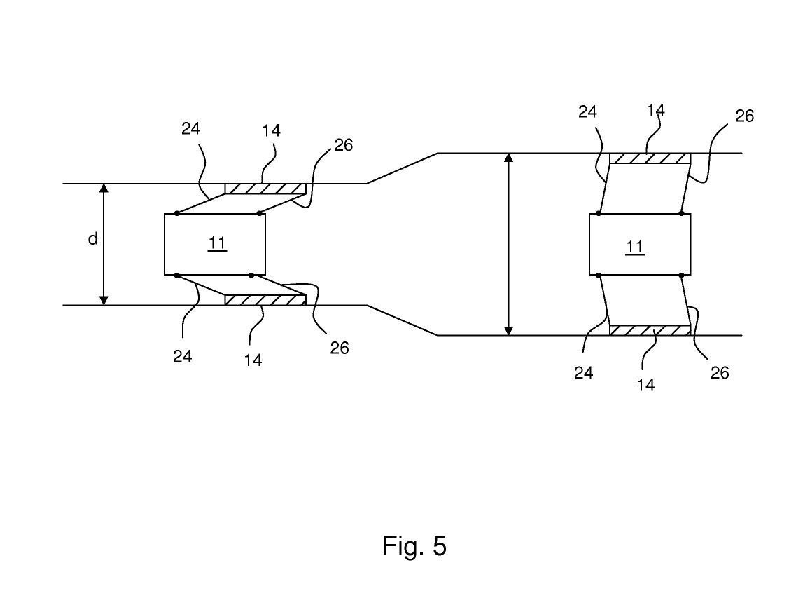

As shown in FIG. 5, according to an embodiment, the apparatus 10 is suited for use in inspecting a pipeline having a first section with a first bore diameter D and a second section with a second bore diameter d (for example, less than or greater than the first bore diameter D). The apparatus 10 can be sent on a continuous run through said first and second sections of the pipeline. The mechanism 22 is used to bias the sensor unit 14 against an inner surface of the first section and to automatically bias the sensor unit 14 against an inner surface of the second section upon a change in bore diameter between said first and second sections of the pipeline.

An apparatus 10 according to an embodiment of the present invention permits accurate modelling of the biasing forces required to maintain the skid 18 in contact with the pipe wall, providing an improvement over conventional skid designs.

An apparatus 10 according to an embodiment of the present invention reduces the time required to design a skid for a given diameter of pipe, by allowing the required forces to be calculated in an early stage in the design procedure, reducing or obviating the need for optimization loops and other acts of trial and error.

Moreover, the linkage 28 permits use of the apparatus 10 across a range of pipeline diameters, including improved tracking of the pipe bore, especially in bends and through restrictive pipeline features such as tapers, valves, etc.

Each linkage 28 can move independently with respect to the other linkages 28 on the vessel 11. This enables the apparatus 10 to pass through and inspect tight bend diameters and difficult or restrictive pipeline features such as tapers, valves, etc. Embodiments of the present invention are capable of inspection through ID bends and mitre bends.

In the embodiment illustrated in FIG. 1, the linkage 28 takes the form of a 4-bar linkage, comprising the body 12, suspension members 24, 26 and carrier 30. Other forms of collapsible linkage may be applicable, for example, a 5-bar linkage comprising said suspension members 24, 26, configured to ensure that the sensor unit 14 tracks the pipe wall irrespective of the attitude of the internal pig body 12 within the pipeline.

Although FIG. 1 is described with spring-loaded suspension members 24, 26 in the form of pivotable arms or struts, other types of suspension may be employed. Although FIG. 3 is described with leaf springs 32 for local biasing of the sensor unit 14 on the carrier 30, other forms of resilient biasing elements may be incorporated. Although FIG. 4 shows an embodiment having a ring of four sensor units 14, other embodiments may consist of three or more sensor units per ring. Multiple rings of sensor units 14 may be included in each vessel 11.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended and are understood to be within the scope of the claims.

What is claimed is:

1. An apparatus for pipeline inspection, the apparatus comprising:
a body comprising a longitudinal axis;
a sensor unit in association with the body, wherein the sensor unit comprises:
an array of ultrasonic sensors configured to inspect a pipe wall; and
a skid comprising an outer surface configured to run adjacent to, or in contact with, the pipe wall, wherein the array of ultrasonic sensors are arranged at a stand off from the outer surface of the skid; and
a mechanism configured to bias the outer surface of the skid into contact with the pipe wall, and to move the sensor unit between a first radial position and a second radial position in response to changes in pipe diameter.

2. The apparatus according to claim 1, wherein the mechanism is configured to bias the sensor unit in the direction of the pipe wall in both the first radial position and the second radial position.

3. The apparatus according to claim 1, wherein the mechanism comprises a first suspension member and a second suspension member, wherein the first suspension member and the second suspension member are configured to bias the sensor unit in a radial direction, and wherein the first suspension member and the second suspension member are axially off set from one another with respect to the longitudinal axis of the body.

4. The apparatus according to claim 3, wherein the first suspension member and the second suspension member are configured to pivot relative to the longitudinal axis of the body.

5. The apparatus according to claim 4, wherein the first suspension member and the second suspension member form part of a linkage configured to move the sensor unit radially, with respect to the longitudinal axis of the body, between the first radial position and the second radial position in response to changes in pipe diameter.

6. The apparatus according to claim I, wherein the mechanism defines a collapsible linkage configured to move the sensor unit radially, with respect to the longitudinal axis of the body, between the first radial position and the second radial position in response to changes in pipe diameter.

7. The apparatus according to claim 6, wherein the linkage comprises a first suspension member and a second suspension member configured to pivot relative to the longitudinal axis of the body and to move the sensor unit radially, with respect to the longitudinal axis of the body, between the first radial position and the second radial position.

8. The apparatus according to claim 7, wherein the linkage comprises a carrier configured to move with the first suspension member and the second suspension member, wherein the carrier is configured to remain parallel with the longitudinal axis of the body during the movement of the sensor unit.

9. The apparatus according to claim 8, wherein the sensor unit is mounted on the carrier.

10. The apparatus according to claim 1, wherein the sensor unit is mounted on a carrier, wherein the carrier is mounted between a first suspension member and a second suspension member, wherein the first suspension member and the second suspension member are configured to pivot relative to the longitudinal axis of the body and to move the sensor unit between a first radial position and a second radial position in response to changes in pipe diameter.

11. The apparatus according to claim 10, wherein the carrier comprises biasing elements configured to locally bias the sensor unit in a radial direction.

12. The apparatus according to claim 11, wherein the carrier is configured to move with the first suspension member and the second suspension member, and to remain parallel with the longitudinal axis of the body during the movement of the sensor unit.

13. The apparatus according to claim 1, wherein the apparatus comprises multiple sensor units movably mounted on the body.

14. A method of pipeline inspection using an apparatus comprising a sensor unit comprising an array of ultrasonic sensors configured to inspect a pipe wall, a skid comprising an outer surface configured to run adjacent to, or in contact with, the pipe wall, and a mechanism configured to bias the outer surface of the skid into contact with the pipe wall, the pipeline comprising a first section with a first bore diameter and a second section with a second bore diameter which is different from the first bore diameter, the method comprising:
moving the apparatus on a continuous run through the first section and the second section of the pipeline;
positioning, with the mechanism, the sensor unit against an inner surface of the first section of the pipeline; and
automatically repositioning, with the mechanism, the sensor unit against an inner surface of the second section of the pipeline upon a change in bore diameter between the first section and the second section of the pipeline.

15. The method according to claim 14, further comprises:
biasing the sensor unit from a first radial position to a second radial position upon a change in bore diameter between the first section and the second section of the pipeline, if the second bore diameter is greater than the first bore diameter.
